(19) United States
(12) Patent Application Publication
(10) Pub. No.: US 2009/0045641 A1
(43) Pub. Date: Feb. 19, 2009

(54) Compact Hand Tool and Packaging For a Hand Tool

(76) Inventors: Tim Macartney Snape, East Perth (AU); Roland Tyson, East Perth (AU); Paramjeet Singh, East Perth (AU)

Correspondence Address: EDELL, SHAPIRO & FINNAN, LLC, 1901 RESEARCH BOULEVARD, SUITE 400, ROCKVILLE, MD, 20850, US

(21) Appl. No.: 11/840,317

(22) Filed: Aug. 17, 2007

(51) Int. Cl. A01B 1/22; A45C 11/00

(52) U.S. Cl. 294/55; 206/349; 294/57

(57) ABSTRACT

A compact hand tool comprising an operating portion terminating in a collar and a handle portion adapted to be received within the collar. The handle portion is operable to be securely retained in a first position where the hand tool may be used to perform its normal function as determined by the operating portion. The handle portion is slidably movable to a second position where the handle portion overlays the operating portion to facilitate storage of the hand tool. The hand tool is made of a substantially light-weight material.

### FIELD

The invention relates to a hand tool and packaging for a hand tool. The invention is particular directed to a compact camp trowel for digging cat holes.

### BACKGROUND

The following discussion of the background to the invention is intended to facilitate an understanding of the present invention. However, it should be appreciated that the discussion is not an acknowledgment or admission that any of the material referred to was published, known or part of the common general knowledge in any jurisdiction as at the priority date of the application.

Wilderness environments are commonly becoming polluted with waste generated by the people who visit such environments. In an effort to minimise such pollution, a set of ethical camping principles has been developed and awareness of these principles is increasing. One aspect of these principles relate to disposal of human faeces and bio-degradeable kitchen waste by way of cat holes.

The problem with cat holes is that a cat hole may be formed in loose soil or hard ground. In the former case, existing hand trowels may be used to form the cat hole. In hard ground areas, however, existing hand trowels may not be able to form the required cat holes.

This problem can be overcome by campers taking a stronger hand trowel. However, existing hand tools capable of digging in hard ground are heavy. In the case of backpackers or other campers travelling primarily by self-power means (eg. foot or cycle), the amount of weight of the hand trowel may result in that person leaving it behind meaning that they have no means of forming cat holes in hard ground.

An alternative means of overcoming the above problem is to take a larger trowel. This may, or may not overcome the weight problem mentioned in the last paragraph, it does result in additional space being taken up by the trowel which the camper may otherwise use for storage.

It is therefore an object of the present invention to provide a hand trowel that is both relatively compact and light-weight compared to similar existing hand trowels.

### SUMMARY

Throughout this document, unless otherwise indicated to the contrary, the terms “comprising”, “consisting of”, and the like, are to be construed as non-exhaustive, or in other words, as meaning “including, but not limited to”.

In accordance with a first aspect of the present invention there is a compact hand tool comprising:
an operating portion terminating in a collar; and
a handle portion adapted to be received within the collar

where, in use the handle portion is operable to be securely retained in a first position where the hand tool may be used to perform its normal function as determined by the operating portion and able to be slidably moved to a second position where the handle portion overlays the operating portion to facilitate storage of the hand tool, the hand tool being made substantially of a light-weight material.

The hand tool preferably includes a spring latch having a locking lug provided thereon and the handle portion and collar have apertures provided therein, where the locking lug is adapted to be received within the aperture provided in the handle portion and where, in the first position, the apertures are aligned relative to each other and the handle portion is securely retained in the first position by the receipt of the locking lug in the aligned apertures. The spring latch may take a variety of forms including:
a resilient arm;
a “C”-shaped member; or
a compression spring.

Preferably, the spring latch takes the form of a “C”-shaped member that is adapted to the interior profile of the handle portion. In this manner, the spring latch does not take up space within the handle portion that could otherwise be used for storage.

The collar may have a raised lip provided thereon to facilitate depression of the locking lug as the handle slides from the second position to the first position.

The handle portion may include two opposing locking apertures provided therein adapted to receive retaining lugs of a cap therein. As mentioned above, the handle portion can operate as a storage compartment accessible by way of the cap. The cap may be retained to the handle portion or detachable therefrom. In its retained variations, the cap may be hingedly fixed to the handle portion or slidably connected to the handle portion.

One or more tools or facilities may be integrally formed with the cap. Alternatively, one or more tools or facilities may be detachably formed with the cap.

To assist in moving the handle portion from the first position to the second position, the aperture in the collar may be provided in a recess. The recess may be shallower on one side of the aperture relative to the other to facilitate depression of the locking lug when received in the aperture.

The light-weight material used to construct the hand tool may be one of the following: 6066-T6 alloy; 7075-T6 alloy; an aluminium alloy; stainless steel; or a titanium alloy. Preferably, the surface of the operating portion material is hardened to at least Rockwell HRC50 in order to resist scratching from hardened ground.

The operating portion may take many forms, for instance it may take the form of a trowel blade or rake.

In accordance with a second aspect of the invention there is packaging for a hand tool according to any preceding claim, comprising two halves, one half having an opening therein and being shaped substantially similar to, but slightly larger than, the hand tool so as to allow the handle portion to move from the first to the second position, and vice-versa, while the hand tool remains in the packaging.

### BRIEF DESCRIPTION OF THE DRAWINGS

The invention will now be described, by way of example only, with reference to the accompanying drawings, in which:

FIG. 1 is a plan view of a hand tool according to the present invention, the hand tool arranged in a first, usable position.

FIG. 2 is a plan view of the hand tool shown in FIG. 1, the hand tool arranged in a second, storage position.

### DETAILED DESCRIPTION

Exemplary embodiments of the present invention are now described in detail. The terminology used herein is for the purpose of describing particular embodiments only, and is not intended to limit the scope of the present invention.

In accordance with a first exemplary embodiment of the present invention there is a compact hand tool 10 in the form of a trowel. The hand tool 10 comprises an operating portion 12, a handle portion 14, a spring latch 16 and a cap 37.

The operating portion 12 has a blade section 18 and a collar 20. The blade section 18 is similar in shape to a rounded arch 22 The base 24 of the arch 22 is also substantially rounded. A division line 26 extends from the apex of the arch 22 to the apex of the base 24. The sides of the arch 22 either side of the division line 26 extend away therefrom such that a very shallow “V”-shaped profile of the blade section 18 is evident from cross-section AA.

Each side has a raised rib 30 protruding therefrom. The ribs 30 provide additional strength to the operating portion 12.

Extending from the circumference of the arch 22, excluding the base 24, are side walls 28. The side walls 28 increase in gradient as it gets closer to the collar 20. The side walls 28 eventually narrow towards each other to meet with the collar 20 so as to form a single integrated component.

The collar 20 has a raised hemispherical lip 32 protruding therefrom. The raised hemispherical lip 32 extends between the point of connection of side walls 28 with the collar 28.

An aperture 34 and semi-circular recess 36 are also formed in the collar 20 near the raised hemispherical lip 32. The aperture 34, semi-circular recess 36 and the raised hemispherical lip 32 are in substantial alignment to each other. This alignment is such that, if the hand tool 10 is viewed in profile, the alignment of the aperture 34, semi-circular recess 36 and raised hemispherical lip 32 is also in substantial alignment with the division line 26.

The handle portion 14 is tubular. The dimension and shape of the handle portion 14 is such that a close fit is achieved when the handle portion 14 is received within the collar 20. The respective ends 38, 40 of the handle portion 14 are diagonally cut such that cross-section BB shows the handle portion 14 to be similar to a parallelogram.

Formed at end 38 is a retaining aperture 42. The position of the retaining aperture 42 is such that, when the handle portion 14 is received within the collar 20, aperture 34 and retaining aperture 42 align.

Positioned near end 40 are two opposing locking apertures 44. Located centrally relative to the locking apertures 44 is a second hemispherical recess 46. A cap 48 is adapted to be retained by the locking apertures 44 and the second hemispherical recess 46.

The cap 48 has a thumb rest 50 protruding from a first end 52. Extending from the first end 52 to a second end 54 is a pair of locking arms 56. Each locking arm 56 has a retaining lug 58 thereon extending away from the cap 48 at a position adjacent second end 54. Each retaining lug 58 is sized so as to provide a firm fit with locking apertures 44. Each locking arm 56 is also made of a resilient material.

The spring latch 16 is bent to form a “C” shape. Positioned at an end of the spring latch 16 is a locking lug 60. The locking lug 60 is sized so as to provide a firm fit with aperture 34 and retaining aperture 42 when such apertures are aligned. The spring arm 16 is made of a resilient material.

Cap 37 is of substantially identical construction to cap 48. However, locking arms 56 are omitted and an additional cut-away portion (not shown) is included. The spring latch 16 is able to be received around the portion of the cap 37 to be received within the handle portion 14 such that the portion of the spring latch 16 having the locking lug 60 is able to depress into the cut-away portion. The dimensions of the portion of the cap 37 to be received with the handle portion 14, having the spring latch 16 arranged thereabout, is such that the cap is securely fitted to the interior of the handle portion 14.

In this embodiment, the operating portion 12 and the handle portion 14 are both made from a high-strength, ultra-light aluminium alloy. Furthermore, the alloy used to form the operating portion 12 is strengthened so that it is hard anodized to Rockwell HRC70.

The invention will now be described with reference to its method of construction and intended use.

In constructing the hand tool 10, the cap 48 is first fitted to the handle portion 14. This is achieved by deforming the locking arms 56 so that the retaining lugs 58 and a portion of the cap 48 is received within the handle portion 14. The cap 48 is then pushed further into the handle portion 14 until such time as each retaining lug 58 is received within its respective locking aperture 44. At this point, thumb rest 50 should also be received within second hemispherical recess 46.

The spring latch 16 is then expanded to fit over cap 37 such that the locking lug 60 is able to be depressed into the cut-away portion of the cap 37. The cap 37 is then fitted into the handle portion 14. This is achieved by deforming, in part, the spring latch 16 so as to allow locking lug 60 to be received within retaining aperture 42.

The handle portion 14 is then slidably fitted to the collar 20 of the operating portion 12. The handle portion 14 is then locked into place relative to the operating portion 12 by way of locking lug 60 further engaging with aperture 34.

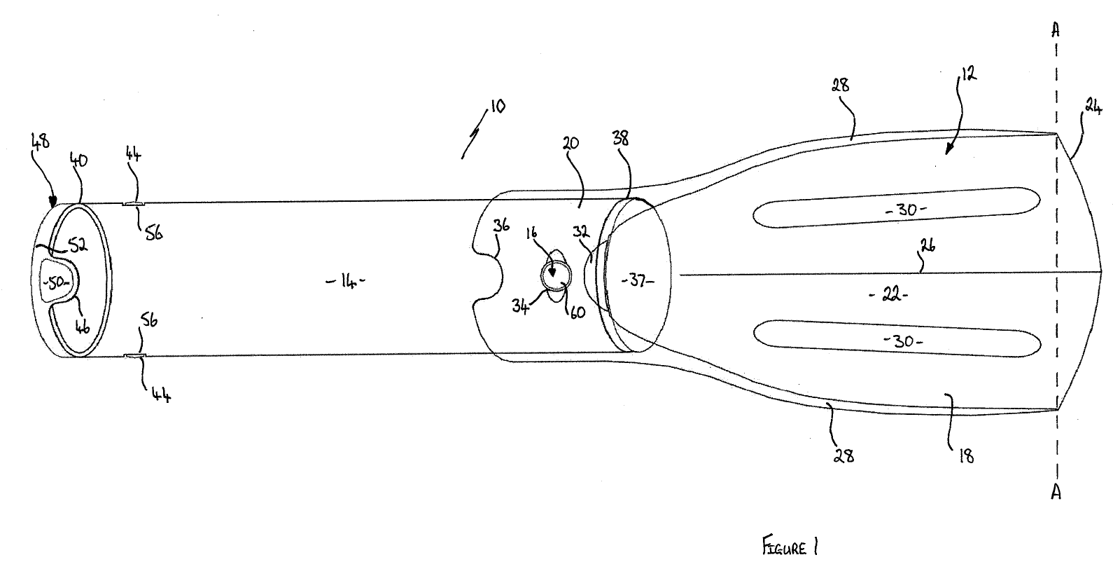

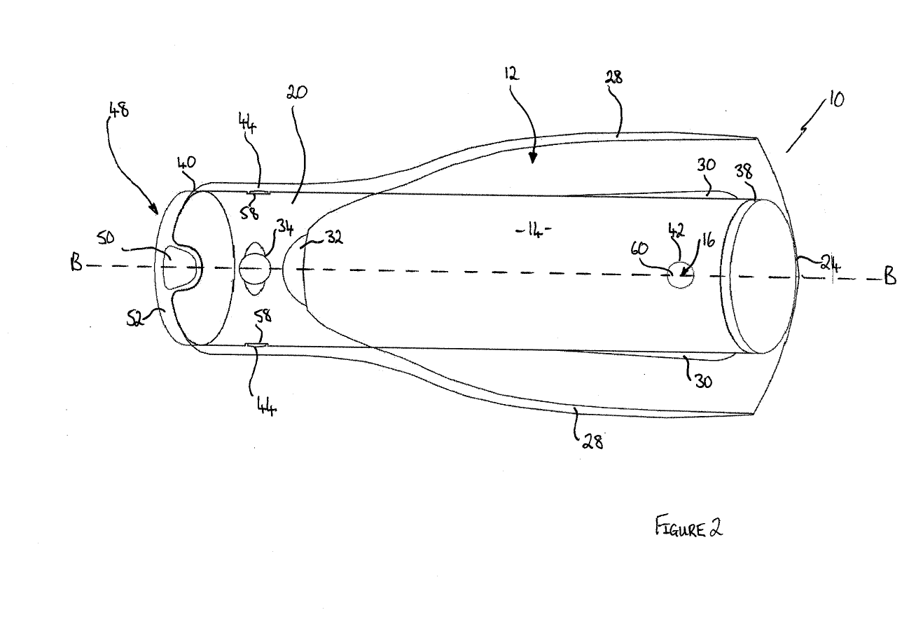

In use, the hand tool 10 is set to a first, usable position as shown in FIG. 1. In this position the handle portion 14 extends from the collar 20 away from the operating portion 12. The handle portion 14 is firmly locked in this position by the retention of the locking lug 60 within both the aligned aperture 34 and retaining aperture 42.

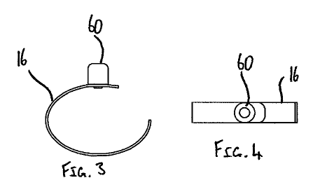

Once a user has finished with the hand tool 10 and wishes to pack it away, the user depresses the locking lug 60. This depression causes the spring latch 16 to compress to a level where the locking lug 60 is free of aperture 34. With the locking lug 60 so free, the handle portion 14 is able to move in the direction illustrated by the arrow C. Movement in this direction is restricted by the thumb rest 50 being received within semi-circular recess 36. When the thumb rest 50 is received within semi-circular recess 36 as described, the hand tool 10 is set to its second, storage position as shown in FIG. 2. The hand tool 10 is firmly maintained in this second position by the retaining lugs 58 pressing against the side of the collar 20 until such time as the user wishes to make use of the hand tool 10.

Movement in the reverse direction is restricted by the locking lug 60 once again being depressed until it is aligned with aperture 34 and retaining aperture 42 at which time the spring latch 14 partially decompresses causing the locking lug 60 to be received within aperture 34. This depression is facilitated by the shape of the raised hemispherical lip 32.

In either the first or second position, the user is able to store small items in the handle portion 14. To do so, the user applies force to the thumb rest 50 in a direction opposite to direction A. This force causes the locking arms 56 to deform allowing the retaining lugs 58 to exit their respective locking apertures 44. Without the retaining lugs 58 being held by the locking apertures 44, the cap 48 can be easily removed. The small item(s) can then be stored in the handle portion 14 and the cap 48 replaced.

In accordance with a second embodiment of the invention (not shown), there is packaging for a hand tool as described in the first embodiment of the invention. The packaging consists of two halves. The first half is of a regular shape and has a first aperture provided therein. Protruding from the first half are two holders. The holders are adapted to hold the operating portion 12 when the hand tool 10 is arranged vertically.

The second half has a second aperture provided therein which, when the first half is mated with the second half to form the packaging, aligns with the first aperture. The alignment of the first and second apertures allows the packaging to be hung vertically from display hooks or the like.

The second half is further shaped so as to provide limited movement of the hand tool 10 in the packaging. However, the second half does not conform to the exact shape of the hand tool 10. Instead, the second half has an opening at the opposite end to the end having the second aperture. This opening is sized to provide customer access to aperture 34 and allow the handle portion 14 to extend therethrough as required. Additionally, the second half is dimensioned to provide additional space between the second half and the hand tool so as to allow the locking lug 60 to freely move as the handle portion 14 is manipulated. In this manner, customers are able to use, or be demonstrated the use, of the hand tool 10 without need to remove the hand tool 10 from the packaging.

In accordance with a third embodiment of the invention, where like numerals reference like parts, there is a hand tool 10 substantially as described in the first embodiment of the invention. However, in this embodiment, no cap 37 is provided at end 38. To still allow small item(s) to be stored, and retained, in the handle portion 14, the spring latch 16 operates as a stopping mechanism. Thus, item(s) having a width and shape, or being able to be compressed to a width and shape, substantially equal to the interior shape and size of the handle portion 14 can be securely stored.

It should be appreciated by the person skilled in the art that the above invention is not limited to the embodiment described. In particular, the following modifications and improvements may be made without departing from the scope of the present invention:
The means by which the cap 48 is affixed to the handle portion 14 may differ from the method described above. For instance, the cap 48 may be hingedly fixed to the handle portion 48 or may take the form of a sliding recess. Additionally, the cap 48 may be simply sized to provide a secure fit around the handle portion 48.
Aperture 34 need not be positioned in the location described above. Furthermore, multiple apertures 34 may be used as the means of facilitating transfer of the hand tool from the first position to the second position and vice-versa.
The spring latch 16 may be replaced by mechanisms of similar function (including one or two-piece mechanisms). For instance, a resilient arm having the locking lug 60 provided at one end thereof may be used in its place. In this arrangement, the end of the resilient arm not having the locking lug 60 provided thereon may be affixed to the inside of the handle portion 14. Alternatively, a compression spring having a locking lug 60 provided thereon could be used. The advantage of the configuration described above, however, is that the compression spring does not substantially reduce the storage space available in the handle portion 14.
The end of the handle portion 14 not being adapted to receive the cap 48 in the third embodiment may be closed to allow for storage of smaller item(s) not able to be retained by the spring latch 16 in the manner described above.
The operating portion 12 of the hand tool 10 described above has been formed to allow the hand tool 10 to be used as a camp trowel. However, the hand tool 10 should not be considered restricted to having such an operating portion. In its place any operating portion adapted to perform a function where the size and shape of the operating portion allow the handle portion 14 to slide thereover can be used.
The handle portion 14 and collar 20 may be of any shape provided that the combination have cross-sections that do not allow the handle portion 14 to rotate relative to the collar 20.
Additional tools or facilities (such as bags) may be pre-stored in the handle portion 14. In yet a further alternative arrangement, such tools or facilities may be formed as part of the cap 48.
Aperture 34 may be provided in a recess. To facilitate depression of the button, the recess may be shallower at one side relative to the other.
Cap 48 may have a slot provided therein. Such a slot is adapted to receive a pre-cut piece of tough fabric therethrough, the fabric expanding at one end thereof so as to prevent the fabric from being pulled completely through the slot. Preferably, the piece of fabric has a hole therein to facilitate attachment of a lanyard or other like device.
Ideally, the hand tool is made from material having a surface hardness between HRC50 and HRC80 on the Rockwell scale, while maintaining a weight of less than 150 gms. For instance, the hand tool may be made from an aluminium alloy such as a 6066-T6 or 7075-T6 alloy or by a stainless steel or a titanium alloy

Furthermore, the features described in the above embodiments and the additional features mentioned above may be combined to form yet additional embodiments that fall within the scope of the present invention.

1. A compact hand tool comprising:
an operating portion terminating in a collar; and
a handle portion adapted to be received within the collar;
wherein the handle portion is operable to be securely retained in a first position where the hand tool is operable to perform a function as determined by the operating portion, the handle portion is further operable to be slidably moved to a second position where the handle portion overlays the operating portion to facilitate storage of the hand tool, and the hand tool is constructed of a substantially light-weight material.

2. A compact hand tool according to claim 1, further comprising a spring latch including a locking lug provided thereon, and the handle portion and collar include apertures provided therein, wherein the locking lug is adapted to be received within the aperture provided in the handle portion and wherein, in the first position, the apertures are aligned relative to each other and the handle portion is securely retained in the first position by the receipt of the locking lug in the aligned apertures.

3. A compact hand tool according to claim 2, wherein the spring latch is adapted to surround a portion of a spring cap adapted to be received within the handle portion.

4. A compact hand tool according to claim 2, wherein the spring latch comprises a resilient arm.

5. A compact hand tool according to claim 2, wherein the spring latch comprises a “C” shaped member.

6. A compact hand tool according to claim 2, wherein the spring latch comprises a compression spring.

7. A compact hand tool according to claim 2, wherein the collar includes a raised lip provided thereon to facilitate depression of the locking lug as the handle slides from the second position to the first position.

8. A compact hand tool according to claim 1, wherein the handle portion includes two opposing locking apertures provided therein adapted to receive retaining lugs of a cap therein.

9. A compact hand tool according to claim 8, wherein the handle portion operates as a storage compartment, accessible via the cap.

10. A compact hand tool according to claim 8, wherein the cap is hingedly fixed to the handle portion.

11. A compact hand tool according to claim 8, wherein the cap is slidably connected to the handle portion.

12. A compact hand tool according to claim 8, further comprising one or more tools or facilities that are integrally formed with the cap such that the one or more tools are stored within the handle portion when the cap is in a closed position.

13. A compact hand tool according to claim 8, further comprising one or more tools or facilities that are detachably formed with the hand tool, wherein the one or more tools are stored within the handle portion when attached to the hand tool.

14. A compact hand tool according to claim 2, wherein the aperture in the collar is provided in a recess to facilitate depression of the locking lug when received within the aperture, the recess being shallower on one side of the aperture relative to the other.

15. A compact hand tool according to claim 1, wherein the light-weight material comprises at least one of a high-strength aluminium alloy, stainless steel, and a titanium alloy.

16. A compact hand tool according to claim 15, wherein the light-weight material comprises a 6066-T6 alloy or a 7075-T6 alloy.

17. A compact hand tool according to claim 1, wherein the operating portion is hardened to a value of at least HRC50 on the Rockwell scale.

18. A compact hand tool according to claim 1, where the operating portion comprises a trowel blade.

19. A compact hand tool according to claim 1, where the operating portion comprises a rake.

20. A packaging structure for a hand tool, the hand tool comprising an operating portion terminating in a collar and a handle portion adapted to be received within the collar, wherein the handle portion is operable to be securely retained in a first position to facilitate use of the operating portion and is further operable to be slidably moved to a second position where the handle portion overlays the operating portion to facilitate storage of the hand tool, wherein the packaging structure comprises two mated halves, one half including an opening therein and being shaped substantially similar to, but slightly larger than, the hand tool so as to allow the handle portion to move from the first position to the second position, and vice-versa, while the hand tool remains within the packaging structure.

21. A compact hand tool according to claim 1, wherein the handle portion is configured to slidably move through the collar to the second position without disconnecting from the operating portion, and the operating portion comprises a tool section and the collar, the collar being formed entirely at one end of the operating portion such that the collar does not interfere with use of the tool section.

22. A packaged tool product comprising:
a compact hand tool comprising an operating portion terminating in a collar, and a handle portion adapted to be received within the collar, wherein the handle portion is operable to be securely retained in a first position where the hand tool is operable to perform a function as determined by the operating portion, and the handle portion is further operable to be slidably moved to a second position where the handle portion overlays the operating portion to facilitate storage of the hand tool; and
a packaging structure for the hand tool, the packaging structure comprising two mated halves, one half including an opening therein and being shaped substantially similar to, but slightly larger than, the hand tool so as to allow the handle portion to move from the first position to the second position, and vice-versa, while the hand tool remains within the packaging structure.
